(19) United States
(12) Patent Application Publication
(10) Pub. No.: US 2026/0058419 A1
(43) Pub. Date: Feb. 26, 2026

(54) FERRITE CORE BUILT-IN CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuki HASHIMOTO, Mie (JP); Seido NISHIJIMA, Mie (JP); Akio KIMURA, Mie (JP)

(21) Appl. No.: 19/102,410

(22) PCT Filed: Aug. 17, 2023
(86) PCT No.: PCT/JP2023/029652

§ 371 Date: Feb. 10, 2025

(30) Foreign Application Priority Data
Aug. 29, 2022 (JP) 2022-136127

(51) Int. Cl. H01R 13/7193; H01R 13/52; H01R 13/7197

(52) U.S. Cl. CPC H01R 13/7193; H01R 13/5216; H01R 13/7197

(57) ABSTRACT

A ferrite core built-in connector is disclosed which suppresses the damage of a ferrite core and has an excellent degree of freedom in selecting a resin material to be used. A ferrite core built-in connector includes a plurality of terminal fittings each configured such that a first connecting portion and a second connecting portion are coupled by an intermediate portion having a strip plate shape, a ferrite core arranged to collectively surround the intermediate portions of the plurality of terminal fittings, and a connector housing for accommodating parts of the plurality of terminal fittings except the first and second connecting portions, and the ferrite core in an embedded state. The intermediate portions of the plurality of terminal fittings are separated from each other across a gap in a plate thickness direction and arranged to overlap each other in projection in the plate thickness direction.

### TECHNICAL FIELD

The present disclosure relates to a ferrite core built-in connector.

### BACKGROUND

Conventionally, for the purpose of suppressing noise in power transmission between in-vehicle devices, in which a switch is made from an alternating current circuit to a direct current circuit, such as a motor and an inverter, a ferrite core built-in connector, in which a ferrite core is arranged around terminal fittings, has been used as disclosed in Patent Document 1. If the connector is formed by embedding the ferrite core together with the terminal fittings in a connector housing made of synthetic resin by insert molding, the ferrite core may be damaged due to a shrinkage force when the resin is cured. Accordingly, a measure for molding a connector housing with an assembly of terminal fittings and a core molded body surrounded in advance by a protecting portion made of a resin material softer than the connector housing as an insert is proposed in a joint connector disclosed in Patent Document 2. According to this, since the ferrite core is surrounded by the protecting portion made of the resin material softer than the connector housing, a shrinkage force of the connector housing during the molding of the connector housing is absorbed by the protecting portion and the damage of the ferrite core can be suppressed.

### PRIOR ART DOCUMENT

### Patent Document

Patent Document 1: JP 2009-295340 A
Patent Document 2: JP 2015-053202 A

### SUMMARY OF THE INVENTION

### Problems to be Solved

However, in the measure of Patent Document 2, the protecting portion needs to be made of the resin material softer than the connector housing. Thus, for example, if a high heat resistance is required, it may not be possible to satisfy the heat resistance requirement by the resin material of the protecting portion.

Accordingly, a ferrite core built-in connector is disclosed which suppresses the damage of a ferrite core and has an excellent degree of freedom in selecting a resin material to be used.

### Means to Solve the Problem

The present disclosure is directed to a ferrite core built-in connector with a plurality of terminal fittings each configured such that a first connecting portion and a second connecting portion are coupled by an intermediate portion having a strip plate shape, a ferrite core arranged to collectively surround the intermediate portions of the plurality of terminal fittings, and a connector housing for accommodating parts of the plurality of terminal fittings except the first and second connecting portions and the ferrite core in an embedded state, the intermediate portions of the plurality of terminal fittings being separated from each other across a gap in a plate thickness direction and arranged to overlap each other in projection in the plate thickness direction.

### Effect of the Invention

According to the present disclosure, it is possible to provide a ferrite core built-in connector which suppresses the damage of a ferrite core and has an excellent degree of freedom in selecting a resin material to be used.

### BRIEF DESCRIPTION OF THE DRAWINGS

FIG. 1 is a perspective view showing a ferrite core built-in connector according to a first embodiment with a connector housing shown in a see-through state.

FIG. 2 is a front view of the ferrite core built-in connector shown in FIG. 1.

FIG. 3 is a section, corresponding to a cross-section along III-III of FIG. 4, of the ferrite core built-in connector shown in FIG. 1.

FIG. 4 is a section along IV-IV in FIG. 2.

FIG. 5 is a section along V-V in FIG. 4.

FIG. 6 is an exploded perspective view showing terminal fittings constituting the ferrite core built-in connector shown in FIG. 1.

FIG. 7 is a perspective view showing a ferrite core built-in connector according to a second embodiment.

FIG. 8 is a perspective view showing a ferrite core built-in connector according to a third embodiment.

FIG. 9 is a vertical section, corresponding to FIG. 3, of a ferrite core built-in connector according to a fourth embodiment.

### DETAILED DESCRIPTION TO EXECUTE THE INVENTION

### Description of Embodiments of Present Disclosure

First, embodiments of the present disclosure are listed and described.

(1) The ferrite core built-in connector of the present disclosure is provided with a plurality of terminal fittings each configured such that a first connecting portion and a second connecting portion are coupled by an intermediate portion having a strip plate shape, a ferrite core arranged to collectively surround the intermediate portions of the plurality of terminal fittings, and a connector housing for accommodating parts of the plurality of terminal fittings except the first and second connecting portions and the ferrite core in an embedded state, the intermediate portions of the plurality of terminal fittings being separated from each other across a gap in a plate thickness direction and arranged to overlap each other in projection in the plate thickness direction.

According to the ferrite core built-in connector of the present disclosure, the intermediate portions of the plurality of terminal fittings having the strip plate shape are separated from each other across the gap in the plate thickness direction and arranged to overlap each other in projection in the plate thickness direction. Further, the ferrite core for noise removal is arranged to collectively surround the intermediate portions of the respective terminal fittings separated across the gap in the plate thickness direction and arranged to overlap. In this way, a circumferential length of the ferrite core surrounding the plurality of intermediate portions stacked and arranged in the plate thickness direction can be shortened and the ferrite core can be reduced in size as compared to the case where the intermediate portions separated from each other across a gap and arranged in parallel in a plate width direction are surrounded by the ferrite core. As a result, when the connector housing is injection-molded to embed the intermediate portions of the terminal fittings and the ferrite core in the connector housing, the amount of a resin to be disposed around the ferrite core can be reduced. In this way, the damage of the ferrite core during the molding of the connector housing can be suppressed by reducing a shrinkage force of the resin applied to the ferrite core when the resin is cured. Therefore, the structure as described in Patent Document 2 to surround the ferrite core by the resin material softer than the connector housing needs not be adopted. If heat resistance is required, a risk of damaging the ferrite core can be reduced even if the connector housing is molded using a relatively hard resin material (e.g. a material having a high heat resistance such as PBT (polybutylene terephthalate)) excellent in heat resistance, and a degree of freedom in selecting the resin material for the connector housing can also be improved.

Moreover, by shortening the circumferential length (magnetic path length) of the ferrite core, a magnetic path cross-sectional area of the ferrite core can also be reduced while the impedance performance (noise suppression performance) of the ferrite core is maintained. In this way, the ferrite core can be further reduced in size, a shrinkage force during the curing of the connector housing applied to the ferrite core can be reduced, and the damage of the ferrite core can be more effectively prevented.

(2) Preferably, in (1), at least one of the plurality of terminal fittings includes a coupling portion extending in a plate width direction of the intermediate portion from an end part of the intermediate portion on the first connecting portion side and the first connecting portion coupled to the intermediate portion by the coupling portion is arranged at a position shifted from an extension of the coupling portion in the plate width direction, and the first connecting portions of the plurality of terminal fittings overlapped in the plate thickness direction in the intermediate portions are separated from each other across a gap and arranged in parallel in the plate width direction.

That is, due to restrictions based on the shape of mating terminals, the first connecting portions of the plurality of terminal fittings may be required to be separated from each other across the gap and arranged in parallel in the plate width direction. Even in such a case, the intermediate portions of the plurality of terminal fittings can be overlapped each other in the plate thickness direction by providing the coupling portion extending in the plate width direction from the intermediate portion between the intermediate portion and the first connecting portion and arranging the first connecting portion at the position shifted in the plate width direction from the extension of the intermediate portion. In this way, even if the first connecting portions of the plurality of terminal fittings are arranged in parallel in the plate width direction, it is possible to enjoy an effect of reducing the amount of the resin of the connector housing by the size reduction of the ferrite core of the present disclosure and an effect of maintaining the impedance performance by a short magnetic path length.

(3) Preferably, in (1) or (2), at least one of the terminal fittings including the coupling portion includes a stepped portion bent into a crank shape in the plate thickness direction on the coupling portion and the intermediate portion and the first connecting portion provided on both sides of the stepped portion are arranged at height positions shifted from each other in the plate thickness direction, and the first connecting portions of the plurality of terminal fittings overlapped in the plate thickness direction in the intermediate portions are arranged at the same height position in the plate thickness direction by the stepped portion.

That is, due to restrictions based on the shape of the mating terminals, the first connecting portions of the plurality of terminal fittings may be required to be not only arranged in parallel while being separated from each other across the gap in the plate width direction, but also arranged at the same height position in the plate thickness direction. Even in such a case, the intermediate portions of the plurality of terminal fittings can be overlapped each other in the plate thickness direction by providing the coupling portion with the stepped portion and arranging the intermediate portion and the first connecting portion at height positions different from each other. In this way, even if the first connecting portions of the plurality of terminal fittings are arranged in parallel in the plate width direction at the same height position in the plate thickness direction, it is possible to enjoy the effect of reducing the amount of the resin of the connector housing by the size reduction of the ferrite core of the present disclosure and the effect of maintaining the impedance performance by a short magnetic path length.

(4) Preferably, in any one of (1) to (3), the connector housing is made of a resin material having a higher heat resistance than PVC. Since the amount of the resin to be disposed around the ferrite core is reduced by the size reduction of the ferrite core surrounding the plurality of intermediate portions stacked and arranged in the plate thickness direction, the damage of the ferrite core can be suppressed even if the connector housing is made of the resin material having a higher heat resistance than PVC (polyvinyl chloride). Thus, the ferrite core needs not be surrounded by the resin material (PVC or the like) softer than the connector housing as in Patent Document 2, and the connector housing can be molded using the resin material having a higher heat resistance than PVC. As a result, a heat resistance requirement for the connector can be advantageously met. Preferable examples of the resin material having a higher heat resistance than PVC include thermoplastic resins such as PBT, PPS (polyphenylene sulfide), PTFE (polytetrafluoroethylene) and PAI (polyamide-imide) and thermosetting resins such as PI (polyimide resin).

(5) Preferably, in any one of (1) to (4), the connector housing includes a terminal holding portion for holding parts of the plurality of terminal fittings except the first and second connecting portions in an embedded state and a core holding portion molded integrally with the terminal holding portion, the core holding portion holding the ferrite core in an embedded state.

By integrally molding the terminal holding portion and the core holding portion, the connector housing can be formed as a primary molded product, injection molding needs not be performed a plurality of times and manufacturing in a short time and the like due to the simplification of a manufacturing process can be realized. Particularly, since the damage of the ferrite core due to a stress acting during shrinkage after resin molding hardly occurs, the damage of the ferrite core is avoided even if the core holding portion is molded integrally with the terminal holding portion using the same hard resin.

(6) Preferably, in any one of (1) to (4), the connector housing includes a first resin portion for holding parts of the plurality of terminal fittings except the first and second connecting portions in an embedded state and a second resin portion molded separately from the first resin portion, the second resin portion holding the first resin portion and the ferrite core in an embedded state.

The connector housing is molded separately as the first resin portion for holding the plurality of terminal fittings in the embedded state and as the second resin portion for holding the first resin portion and the ferrite core in the embedded state. Thus, the ferrite core built-in connector can be formed as a secondary molded product by, after the first resin portion for holding the terminal fittings in the embedded state is formed as a primary molded product, injection-molding the second resin portion with the primary molded product and the ferrite core as inserts. Since the amount of the resin in the secondary molded product including the ferrite core as an insert can be reduced by as much as the first resin portion, a shrinkage force applied to the ferrite core during the curing of the resin material of the second resin portion can be further reduced and the damage of the ferrite core can be more advantageously prevented or suppressed.

(7) Preferably, in any one of (1) to (6), the connector housing includes an exposure hole for exposing the ferrite core. This is because the amount of the resin of the connector housing is reduced by the exposure hole and the damage of the ferrite core due to a shrinkage force during the curing of the resin material of the connector housing can be more advantageously prevented or suppressed.

(8) Preferably, in any one of (1) to (7), the first and second connecting portions of each terminal fitting respectively project and are exposed from the connector housing on both axial sides of the tubular ferrite core. In this way, for example, the first connecting portions can be arranged to be connectable to a mating connector, whereas the second connecting portions can be connected to ends of wires extending from an internal circuit of an in-vehicle device or the like or the in-vehicle device.

### Details of Embodiments of Present Disclosure

Specific examples of a ferrite core built-in connector of the present disclosure are described below with reference to the drawings. Note that the present disclosure is not limited to these illustrations, but is represented by claims and includes all changes in the scope of claims and in the meaning and scope of equivalents.

### First Embodiment

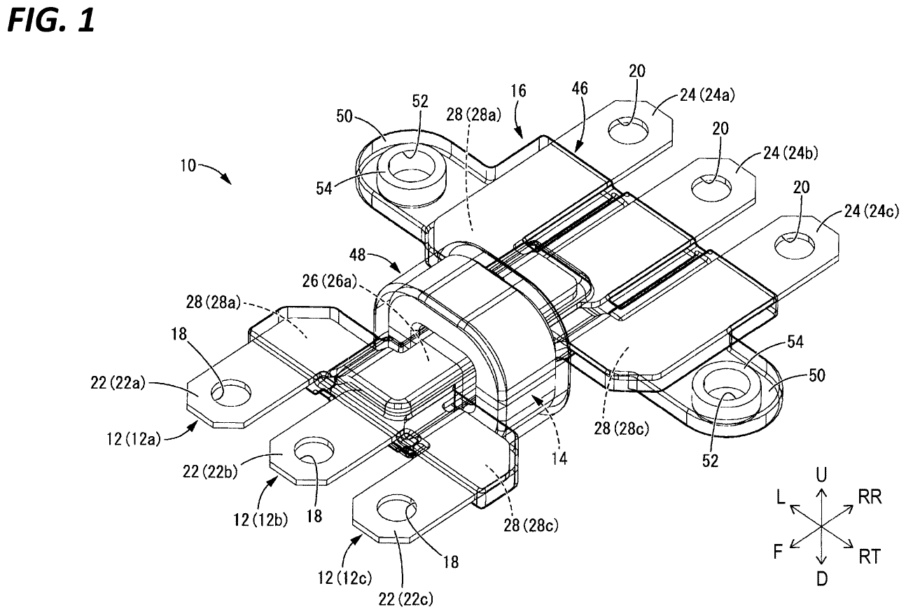

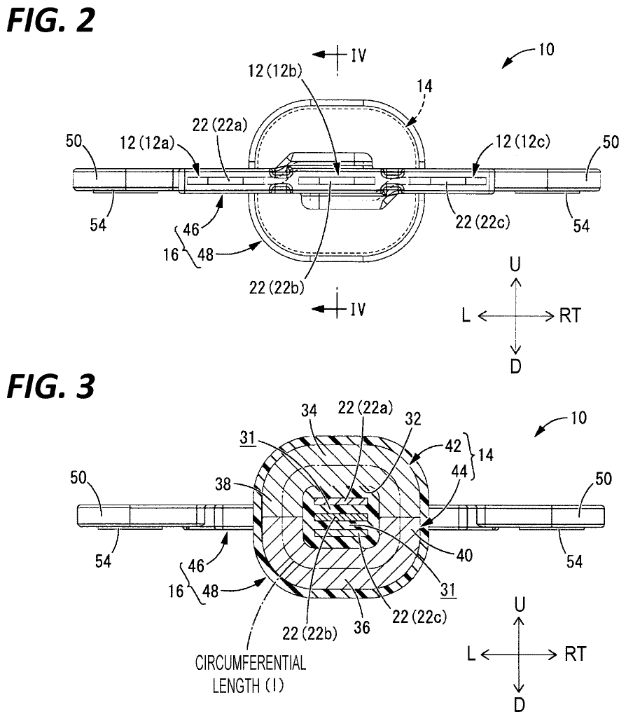

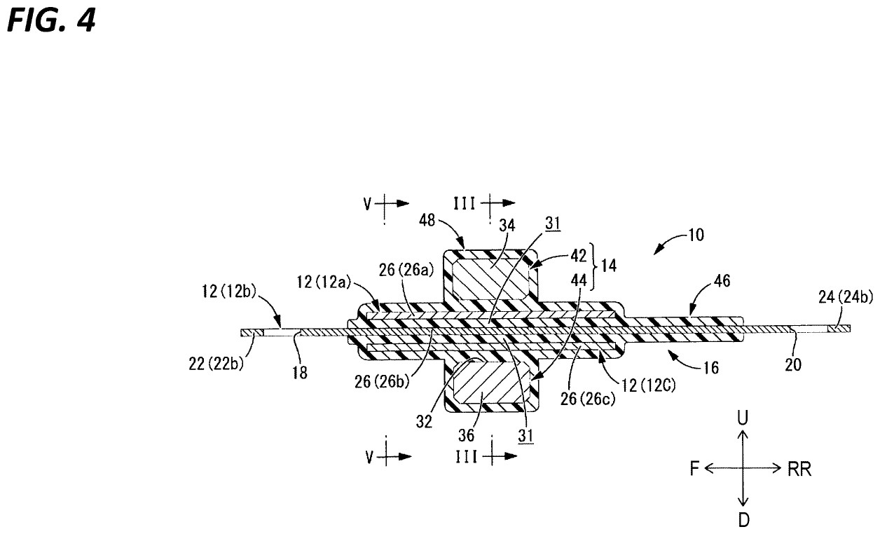

Hereinafter, a ferrite core built-in connector 10 of a first embodiment of the present disclosure is described using FIGS. 1 to 6. The ferrite core built-in connector 10 is, for example, a connector for connecting a motor and a PCU (power control unit), one end of each terminal fitting 12 in the ferrite core built-in connector 10 is electrically connected to the unillustrated motor and the other end of each terminal fitting 12 is electrically connected to the unillustrated PCU. Note that the ferrite core built-in connector 10 can be arranged in an arbitrary orientation, but upper and lower sides in FIG. 1 are referred to as upper and lower sides, left and right sides in FIG. 4 are referred to as front and rear sides and left and right sides in FIG. 2 are referred to as left and right sides below. Further, for a plurality of identical members, only some members may be denoted by a reference sign and the other members may not be denoted by the reference sign.

### (Ferrite Core Built-in Connector 10)

The ferrite core built-in connector 10 is provided with the terminal fittings 12, a ferrite core 14 arranged to surround the terminal fittings 12, and a connector housing 16 for accommodating the terminal fittings 12 and the ferrite core 14. Note that the connector housing 16 is shown in a state where inner members can be seen through.

### (Terminal Fittings 12)

In the first embodiment, a plurality of the terminal fittings 12 are provided. The plurality of terminal fittings 12 are three terminal fittings including a first terminal fitting 12a, a second terminal fitting 12b and a third terminal fitting 12c. Each terminal fitting 12 (first to third terminal fittings 12a to 12c) is constituted by a busbar and, for example, made of electrically conductive metal such as copper, copper alloy, aluminum or aluminum alloy. Any of the first to third terminal fittings 12a to 12c is in the form of a strip extending in a front-rear direction as a whole, a vertical direction is a plate thickness direction and a lateral direction is a plate width direction. The first to third terminal fittings 12a to 12c having a strip plate shape have a plate thickness smaller than a plate width. The first to third terminal fittings 12a to 12c have a substantially constant length (front-rear dimension) as a whole and the front and rear ends thereof are arranged side by side in the lateral direction at the same positions in the front-rear direction. Further, the first to third terminal fittings 12a to 12c have substantially the same width (lateral dimension) in parts except parts formed with coupling portions 28a, 28c to be described later.

A front end part of each of the first to third terminal fittings 12a to 12c is formed with a substantially circular front through hole 18 penetrating in the plate thickness direction (vertical direction). Further, a rear end part of each of the first to third terminal fittings 12a to 12c is formed with a substantially circular rear through hole 20 penetrating in the plate thickness direction (vertical direction). In this way, first connecting portions 22 (respective first connecting portions 22a to 22c) are configured in the front end parts, which are one end parts in the first to third terminal fittings 12a to 12c, and the first connecting portions 22a to 22c are electrically connected to the unillustrated motor. Further, second connecting portions 24 (respective second connecting portions 24a to 24c) are configured in the rear end parts, which are the other end parts in the second to third terminal fittings 12a to 12c, and the second connecting portions 24a to 24c are electrically connected to the unillustrated PCU. Intermediate parts in the front-rear direction between the respective first connecting portions 22 and the respective second connecting portions 24 in the first to third terminal fittings 12a to 12c serve as intermediate portions 26 (respective intermediate portions 26a to 26c). As just described, each terminal fitting 12 is structured such that the first connecting portion 22 and the second connecting portion 24 are coupled by the intermediate portion 26. Each terminal fitting 12 has a strip plate shape having a plate thickness smaller than a plate width and extending in the front-rear direction at least in the intermediate portion 26. In the first embodiment, the plate width of the intermediate portion 26 is smaller than those of the first and second connecting portions 22, 24, and a shorter magnetic path length of the ferrite core 14 disposed to surround the intermediate portions 26 can be set. The plate width of the intermediate portion 26 may be equal to or larger than those of the first and second connecting portions 22, 24.

Coupling portions 28a projecting leftward from both front and rear end parts of the intermediate portion 26a are respectively provided on both front and rear sides of the intermediate portion 26a in the first terminal fitting 12a. The first connecting portion 22a extends forward from a left end part of the front coupling portion 28a, and the second connecting portion 24a extends rearward from a left end part of the rear coupling portion 28a. In this way, the first connecting portion 22a is arranged at a position shifted leftward with respect to a forward extension of the intermediate portion 26a, and the second connecting portion 24a is arranged at a position shifted leftward with respect to a rearward extension of the intermediate portion 26a.

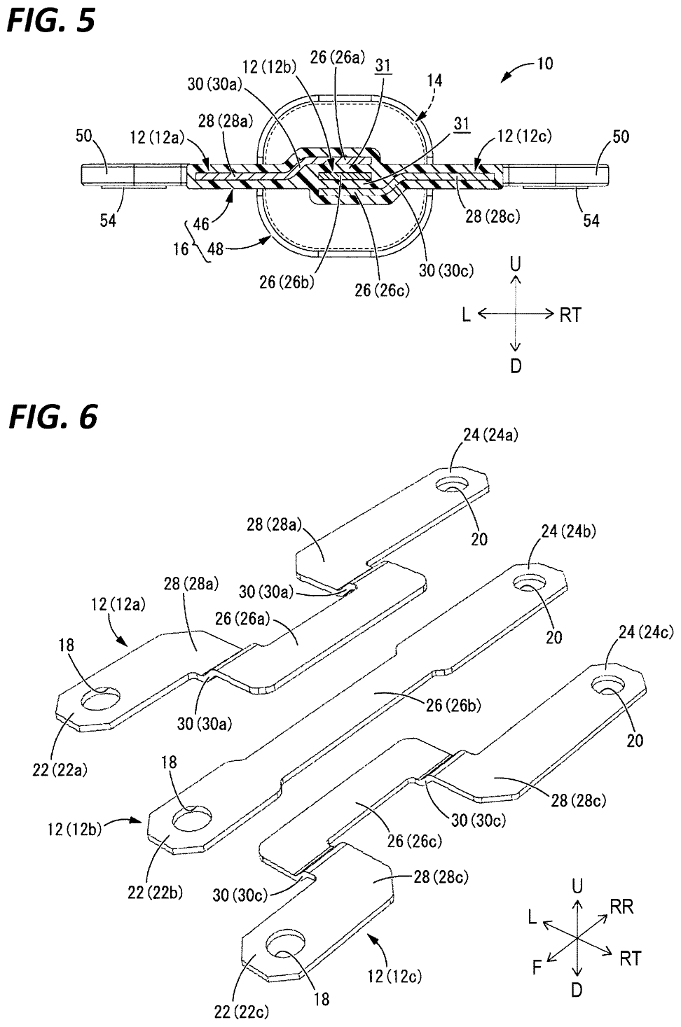

As shown in FIGS. 5 and 6, each coupling portion 28a is provided with a stepped portion 30a extending while being bent into a crank shape in the plate thickness direction. The stepped portion 30a is provided on an end part of the coupling portion 28a on the side of the intermediate portion 26a, and projects downward from a connected end of the coupling portion 28a to the intermediate portion 26a. Accordingly, the first connecting portion 22a and the intermediate portion 26a disposed on both sides of the front stepped portion 30a are arranged at height positions shifted from each other in the plate thickness direction (vertical direction), and the first connecting portion 22a is located below the intermediate portion 26a by the stepped portion 30a. Similarly, the second connecting portion 24a and the intermediate portion 26a disposed on both sides of the rear stepped portion 30a are arranged at height positions shifted from each other in the plate thickness direction (vertical direction), and the second connecting portion 24a is located below the intermediate portion 26 by the stepped portion 30a.

Note that leftward projecting lengths of the front and rear coupling portions 28a, 28a from the intermediate portion 26a are substantially equal to each other. Further, downward projecting lengths of the front and rear stepped portions 30a, 30a from the intermediate portion 26a are substantially equal to each other. Therefore, the first and second connecting portions 22a, 24a are arranged substantially at the same positions in the vertical direction and the lateral direction and located on both front and rear sides.

Further, coupling portions 28c projecting rightward from both front and rear end parts of the intermediate portion 26c are respectively provided in the third terminal fitting 12c. The first connecting portion 22c extends forward from a left end part of the front coupling portion 28c, and the second connecting portion 24c extends rearward from a left end part of the rear coupling portion 28c. In this way, the first connecting portion 22c is arranged at a position shifted leftward with respect to a forward extension of the intermediate portion 26c, and the second connecting portion 24c is arranged at a position shifted leftward with respect to a rearward extension of the intermediate portion 26c.

As shown in FIGS. 5 and 6, each coupling portion 28c is provided with a stepped portion 30c extending while being bent into a crank shape in the plate thickness direction. The stepped portion 30c is provided on an end part of the coupling portion 28c on the side of the intermediate portion 26c, and projects upward from a connected end to the intermediate portion 26c. Accordingly, the first connecting portion 22c and the intermediate portion 26c disposed on both sides of the front stepped portion 30c are arranged at height positions different from each other in the plate thickness direction (vertical direction), and the first connecting portion 22c is located above the intermediate portion 26c by the stepped portion 30c. Similarly, the second connecting portion 24c and the intermediate portion 26c disposed on both sides of the rear stepped portion 30c are arranged at height positions different from each other in the plate thickness direction (vertical direction), and the second connecting portion 24c is located above the intermediate portion 26 by the stepped portion 30c.

Note that rightward projecting lengths of the front and rear coupling portions 28c, 28c from the intermediate portion 26c are substantially equal to each other. Further, upward projecting lengths of the front and rear stepped portions 30c, 30c from the intermediate portion 26c are substantially equal to each other. Therefore, the first and second connecting portions 22c, 24c are arranged substantially at the same positions in the vertical direction and the lateral direction and located on both front and rear sides.

Further, the second terminal fitting 12b is not provided with the coupling portions 28 and the stepped portions 30 and is in the form of a flat plate extending straight in the front-rear direction.

As shown in FIG. 6, the first to third terminal fittings 12a to 12c are so arranged that the intermediate portion 26a of the first terminal fitting 12a and the intermediate portion 26c of the third terminal fitting 12c are located on both sides in the vertical direction and overlapped in projection in the vertical direction with respect to the intermediate portion 26b of the second terminal fitting 12b. The intermediate portions 26a to 26c have substantially the same shape when viewed from the vertical direction and are entirely overlapped in projection in the vertical direction. Predetermined gaps 31 are respectively provided between the facing surfaces of the intermediate portions 26a and 26b and between the facing surfaces of the intermediate portions 26b and 26c, and the intermediate portions 26a to 26c overlapped each other are arranged to overlap while being separated from each other in the vertical direction. A vertical dimension of the gap 31 (distance between the intermediate portions 26, 26 adjacent in the vertical direction) is substantially equal to the plate thickness of the intermediate portion 26 in the first embodiment, but can be changed as appropriate, for example, in consideration of electrical insulation and the like.

By arranging the three plate-like intermediate portions 26a to 26c in a state overlapping each other in projection in the plate thickness direction, a ratio of an outer vertical dimension of the intermediate portions 26a to 26c (distance from the upper surface of the intermediate portion 26a to the lower surface of the intermediate portion 26c) to an outer lateral dimension of the intermediate portions 26 (plate width of the intermediate portions 26) is closer to 1 as compared to the case where the three intermediate portions are arranged in parallel in the plate width direction.

In such an arranged state of the first to third terminal fittings 12a to 12c, the first connecting portions 22a to 22c are arranged in parallel while being separated from each other in the lateral direction by a predetermined distance, and the first connecting portion 22a, the first connecting portion 22b and the first connecting portion 22c are arranged from left. Similarly, the second connecting portions 24a to 24c are arranged in parallel while being separated from each other in the lateral direction by a predetermined distance, and the second connecting portion 24a, the second connecting portion 24b and the second connecting portion 24c are arranged from left. The first connecting portions 22a to 22c are located at the same height position in the vertical direction by the front stepped portions 30a, 30c and arranged in one horizontal plate. Similarly, the second connecting portions 24a to 24c are located at the same height position in the vertical direction by the rear stepped portions 30a, 30c and arranged in one horizontal plate. In the first embodiment, the first connecting portions 22a to 22c and the second connecting portions 24a to 24c are located in one horizontal plane.

### (Ferrite Core 14)

As also shown in FIGS. 3 and 4, the ferrite core 14 has a tubular shape having an axial direction oriented in the front-rear direction as a whole. An internal space 32 of the ferrite core 14 has a laterally long cross-section having a maximum lateral dimension slightly larger than a maximum vertical dimension. The maximum lateral dimension of the internal space 32 is desirably 1.8 times or less than the maximum vertical dimension of the internal space 32, more preferably 1.5 times or less. Further, the ferrite core 14 has a predetermined front-rear dimension, and the front-rear dimension of the ferrite core 14 is smaller than that of the intermediate portion 26 in each terminal fitting 12, smaller than a separation distance in the front-rear direction between the front coupling portion 28a (28c) and the rear coupling portion 28a (28c) in the first embodiment. A conventionally known material is used as a material of the ferrite core 14. In the first embodiment, the ferrite core 14 is made of Mn—Zn based ferrite.

This ferrite core 14 is arranged to collectively surround the intermediate portions 26a to 26c of the first to third terminal fittings 12a to 12c. That is, the ferrite core 14 includes an upper part 34 for covering the intermediate portion 26a located on the uppermost side from above and a lower part 36 for covering the intermediate portion 26c located on the lowermost side from below. Further, the ferrite core 14 includes a left part 38 for covering the intermediate portions 26a to 26c from left by being inserted between the front and rear coupling portions 28a, 28a of the first terminal fitting 12a and a right part 40 for covering the intermediate portions 26a to 26c from right by being inserted between the front and rear coupling portions 28c, 28c of the first terminal fitting 12c.

In the first embodiment, the ferrite core 14 is divisible in the vertical direction and composed of an upper ferrite core 42 located on an upper side and a lower ferrite core 44 located on a lower side. That is, both of the upper and lower ferrite cores 42, 44 have a halved tube shape, and the internal space 32 having a substantially rectangular shape with round corners is configured by overlapping both circumferential end surfaces of the upper and lower ferrite cores 42, 44 each other in the vertical direction to cover the openings of the upper and lower ferrite cores 42, 44 each other.

In short, the upper and lower parts 34, 36 of the ferrite core 14 each having a predetermined lateral dimension are constituted by circumferentially middle parts of the upper and lower ferrite cores 42, 44. Further, the left part 38 of the ferrite core 14 is configured by overlapping left circumferential end parts of the respective upper and lower ferrite cores 42, 44. Similarly, the right part 40 of the ferrite core 14 is configured by overlapping right circumferential end parts of the respective upper and lower ferrite cores 42, 44.

### (Connector Housing 16)

The connector housing 16 is provided with a terminal holding portion 46 and a core holding portion 48. In the first embodiment, the terminal holding portion 46 and the core holding portion 48 are integrally formed. A synthetic resin material for forming the connector housing 16 is not limited, but the connector housing 16 is preferably made of a resin material having a high heat resistance. In the first embodiment, both the terminal holding portion 46 and the core holding portion 48 constituting the connector housing 16 are made of PBT (polybutylene terephthalate), which is a resin material having a higher heat resistance than PVC (polyvinyl chloride). Note that examples of the resin material having a higher heat resistance than PVC include thermoplastic resins such as PBT, PPS (polyphenylene sulfide), PTFE (polytetrafluoroethylene) and PAI (polyamide-imide) and thermosetting resins such as PI (polyimide resin). These materials can be suitably used as the material of the connector housing 16.

### (Terminal Holding Portion 46)

As shown in FIG. 6, the terminal holding portion 46 holds parts of the first to third terminal fittings 12a to 12c except the first connecting portions 22a to 22c and the second connecting portions 24a to 24c in an embedded state. Specifically, the intermediate parts in the front-rear direction (intermediate portions 26a to 26c) in the first to third terminal fittings 12a to 12c are substantially entirely covered. In other words, the first connecting portions 22a to 22c of the first to third terminal fittings 12a to 12c project forward from the terminal holding portion 46, and the second connecting portions 24a to 24c project rearward from the terminal holding portion 46. In the first embodiment, as also shown in FIGS. 3 and 5, the terminal holding portion 46 is provided to also cover the coupling portions 28a of the first terminal fitting 12a and the coupling portions 28c of the third terminal fitting 12c in addition to the intermediate portions 26a to 26c.

Further, leg portions 50, 50 projecting outward in the lateral direction are provided on both sides in the lateral direction of a rear part of the terminal holding portion 46. The leg portions 50 are respectively provided laterally outwardly of the first and third terminal fittings 12a, 12c and respectively include a collar 54 made of metal and having a bolt insertion hole 52 penetrating in the vertical direction. In short, a pair of the collars 54, 54 each having the bolt insertion hole 52 are fixed in the leg portions 50, 50 provided on the rear part of the terminal holding portion 46 and held laterally outwardly of the first and third terminal fittings 12a, 12c. The ferrite core built-in connector 10 is fixed to the motor or the PCU to be connected to the first connecting portions 22a to 22c or the second connecting portions 24a to 24c of the first to third terminal fittings 12a to 12c or an in-vehicle component or the like arranged between the motor and the PCU by unillustrated bolts inserted through the respective bolt insertion holes 52. Note that the connector housing 16 is formed as an integrally molded product provided with the collars 54, 54.

As shown in FIG. 3, the terminal holding portion 46 holds the intermediate portions 26a to 26c disposed to overlap each other in the vertical direction in the embedded state. That is, the terminal holding portion 46 is filled in the internal space 32 of the ferrite core 14 and interposed between the intermediate portions 26a to 26c and the ferrite core 14 while surrounding the intermediate portions 26a to 26c. Further, the terminal holding portion 46 is also filled in the gap 31 between the intermediate portions 26a and 26b and the gap 31 between the intermediate portions 26b and 26c separated and arranged to face each other in the vertical direction, and provided to surround each of the intermediate portions 26a to 26c. Since the terminal holding portion 46 holds the intermediate portions 26a to 26c in the embedded state, the intermediate portions 26a to 26c are positioned in a predetermined arrangement to overlap while being separated from each other in the vertical direction. Further, by filling the terminal holding portion 46 made of electrically insulating resin in the gaps 31 between the intermediate portions 26a to 26c, conduction (short circuit) between the intermediate portions 26a to 26c of the first to third terminal fittings 12a to 12b is prevented.

### (Core Holding Portion 48)

The surface of the ferrite core 14 is covered by the core holding portion 48. The core holding portion 48 is formed integrally with the terminal holding portion 46 and provided to cover the outer peripheral surface and the front and rear end parts of the ferrite core 14, thereby holding the ferrite core 14 in an embedded state. Note that a part for covering the inner peripheral surface of the ferrite core 14 in the connector housing 16 is the terminal holding portion 46 for holding the intermediate portions 26a to 26c of the first to third terminal fittings 12a to 12c in the embedded state and, at the same time, the core holding portion 48 for holding the ferrite core 14 in the embedded state.

In the first embodiment, the terminal holding portion 46 and the core holding portion 48 constituting the connector housing 16 are integrally formed. Particularly, the ferrite core built-in connector 10 can be obtained as a primary molded product (integrally molded product provided with the ferrite core 14 and the collars 54, 54) by one injection molding with the first to third terminal fittings 12a to 12c, the ferrite core 14 and the collars 54, 54 inserted during the molding of the connector housing 16. Therefore, the number of manufacturing steps can be reduced, a manufacturing process is simplified and a manufacturing time is shortened as compared to the case where a plurality of injection molding steps are required.

Even if the terminal holding portion 46 and the core holding portion 48 of the connector housing 16 are integrally molded using the resin material harder than PVC in the ferrite core built-in connector 10, the damage of the ferrite core 14 by a stress acting due to shrinkage after the molding of the connector housing 16 is avoided.

That is, the intermediate portions 26a to 26c of the first to third terminal fittings 12a to 12b inserted through the tubular ferrite core 14 are in the form of plates each having the plate thickness smaller than the plate width, and are arranged to overlap each other in the plate thickness direction. Thus, an inner circumferential length of the ferrite core 14 necessary to mount the ferrite core 14 around the intermediate portions 26a to 26c of the first to third terminal fittings 12a to 12c is shortened, whereby a magnetic path length of the ferrite core 14 can be shortened. As a result, the amount of the resin of the core holding portion 48 can be reduced by reducing a surface area of the ferrite core 14 covered by the core holding portion 48 of the connector housing 16, and a stress applied to the ferrite core 14 due to shrinkage after the molding of the core holding portion 48 is reduced. Thus, the material of the connector housing 16 is hardly limited by necessity to prevent the damage of the ferrite core 14 by molding shrinkage, and can be selected with a large degree of freedom, for example, without being limited to PVC or the like having a small stress acting due to molding shrinkage. Therefore, the terminal holding portion 46 for holding the first to third terminal fittings 12a to 12c in the embedded state and the core holding portion 48 for holding the ferrite core 14 in the embedded state can be integrally molded using a relatively hard resin material suitable as a housing in terms of strength and durability. Particularly, such as when heat resistance is required due to application to an automotive vehicle or the like, a resin material better in heat resistance than PVC such as PBT can be selected and the ferrite core built-in connector 10 excellent in heat resistance can be provided.

Further, by shortening the magnetic path length of the ferrite core 14, a magnetic path cross-sectional area of the ferrite core 14 can be reduced while the impedance performance (noise removal performance) of the ferrite core 14 is maintained. In that way, further size reduction of the ferrite core 14 and further reduction of the stress acting due to the molding shrinkage of the connector housing 16 associated with further size reduction are realized. That is, the impedance performance (noise removal performance) of the ferrite core 14 is calculated by Equation 1 below. In the ferrite core 14 of the first embodiment, a magnetic path length 1 in Equation 1 is set to be small. Therefore, a magnetic path cross-sectional area S can be reduced while necessary impedance performance (L) is maintained, and further size reduction of the ferrite core 14 due to a reduction in the magnetic path cross-sectional area S can be realized while the impedance performance (L) is maintained. Note that, in Equation 1, L denotes an inductance of the ferrite core 14, p denotes a permeability of the ferrite core 14, S denotes the magnetic path cross-sectional area of the ferrite core 14, N denotes a winding number of a conductor wound on the ferrite core 14, and 1 denotes the magnetic path length of the ferrite core 14.

$$L = μ {SN}^{2} / 1 \qquad [ Equation 1 ]$$

In such a ferrite core built-in connector 10 of the first embodiment, the first connecting portions 22 are electrically connected to the unillustrated motor, and the second connecting portions 24 are electrically connected to the unillustrated PCU. Since the first connecting portions 22 project forward in the axial direction of the ferrite core 14 and are exposed from the connector housing 16 and the second connecting portions 24 project rearward and are exposed from the connector housing 16, the first and second connecting portions 22, 24 are easily connected to the devices (motor and PCU) disposed on the both front and rear sides of the ferrite core built-in connector 10.

Further, since the first to third terminal fittings 12a to 12c are provided with the coupling portions 28a to 28c, the first connecting portions 22a to 22c are separated from each other across gaps and arranged in parallel in the lateral direction, which is the plate width direction, while the intermediate portions 26a to 26c are arranged to overlap each other in the vertical direction. In this way, the ferrite core 14 to be externally fit and mounted around the intermediate portions 26a to 26c can be reduced in size while the first connecting portions 22a to 22c cope with a connection structure on the motor side.

The front coupling portions 28a, 28c of the first and third terminal fittings 12a, 12c are provided with the stepped portions 30a, 30c projecting toward one of upper and lower sides, and the first connecting portions 22a to 22c are arranged at the same height in the vertical direction while the intermediate portions 26a to 26c are overlapped each other in the vertical direction. In this way, the ferrite core 14 to be externally fit and mounted around the intermediate portions 26a to 26c can be reduced in size while the first connecting portions 22a to 22c cope with the connection structure on the motor side.

In the first embodiment, similarly to the first connecting portions 22a to 22c, the second connecting portions 24a to 24c are also separated from each other across gaps and arranged in parallel in the lateral direction, and arranged at the same height in the vertical direction. In this way, the ferrite core 14 to be externally fit and mounted around the intermediate portions 26a to 26c can be reduced in size while the second connecting portions 24a to 24c cope with the connection structure on the PCU side.

### Second Embodiment

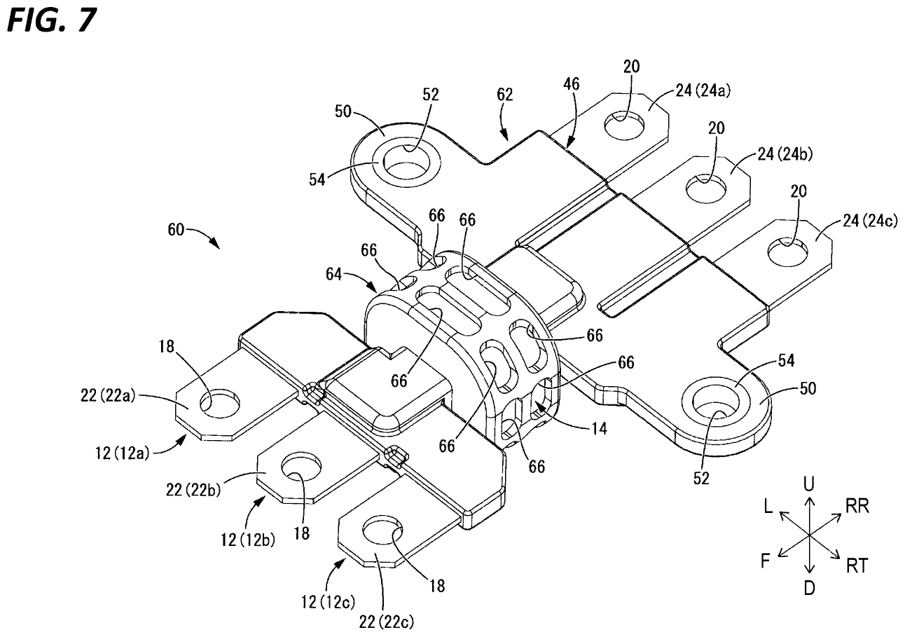

A ferrite core built-in connector 60 of a second embodiment of the present disclosure is described below using FIG. 7. The ferrite core built-in connector 60 of the second embodiment is structured similarly to the ferrite core built-in connector 10 of the first embodiment, but differs in that a core holding portion 64 of a connector housing 62 includes exposure holes 66 for exposing a ferrite core 14. Note that, in the following description, substantially the same members and parts as those of the first embodiment are denoted in FIG. 7 by the same reference signs as in the first embodiment and not described in detail.

Specifically, the exposure holes 66 penetrating in the vertical direction or the lateral direction are formed in a peripheral wall portion covering the outer peripheral surface of the ferrite core 14 in the core holding portion 64. In the second embodiment, a plurality of the exposure holes 66 having a substantially oval cross-sectional shape are formed and arranged in two rows in the front-rear direction and apart from each other at a plurality of positions in a circumferential direction of the core holding portion 64. The outer peripheral surface of the ferrite core 14 is exposed to outside through the plurality of these exposure holes 66.

Note that two exposure holes 66, 66 having a substantially oval shape in a side view are formed to penetrate through the core holding portion 64 in the lateral direction in each of parts for covering a left part (38) and a right part 40 of the ferrite core 14 from laterally outer sides in the core holding portion 64. Further, two exposure holes 66, 66 having a substantially oval shape in a plan view are formed to penetrate through the core holding portion 64 in the vertical direction in each of parts for covering an upper part 34 and a lower part (36) of the ferrite core 14 from vertically outer sides in the core holding portion 64. Further, one exposure hole 66 is also formed between each exposure hole 66 penetrating through the core holding portion 64 in the lateral direction and each exposure hole 66 penetrating through the core holding portion 64 in the vertical direction in the circumferential direction.

Also in the ferrite core built-in connector 60 of the second embodiment, the amount of a resin material for forming the connector housing 62 can be reduced and a stress acting on the ferrite core 14 due to shrinkage after the molding of the connector housing 62 can be reduced by the size reduction of the ferrite core 14 as in the first embodiment. In addition to that, in the second embodiment, the plurality of exposure holes 66 are provided in the peripheral wall portion of the core holding portion 64, whereby the amount of the resin material of the core holding portion 64 provided outside the ferrite core 14 can be further reduced. As a result, a possibility of damage of the ferrite core 14 due to the shrinkage of the resin material and the like can be further reduced during the molding of the core holding portion 64.

Further, since the outer peripheral surface of the ferrite core 14 is exposed to outside through the plurality of exposure holes 66, even if the ferrite core 14 generates heat in noise absorption, the heat can be dissipated to an outside space through the plurality of exposure holes 66 and the ferrite core built-in connector 60 excellent in thermal performance can be provided.

### Third Embodiment

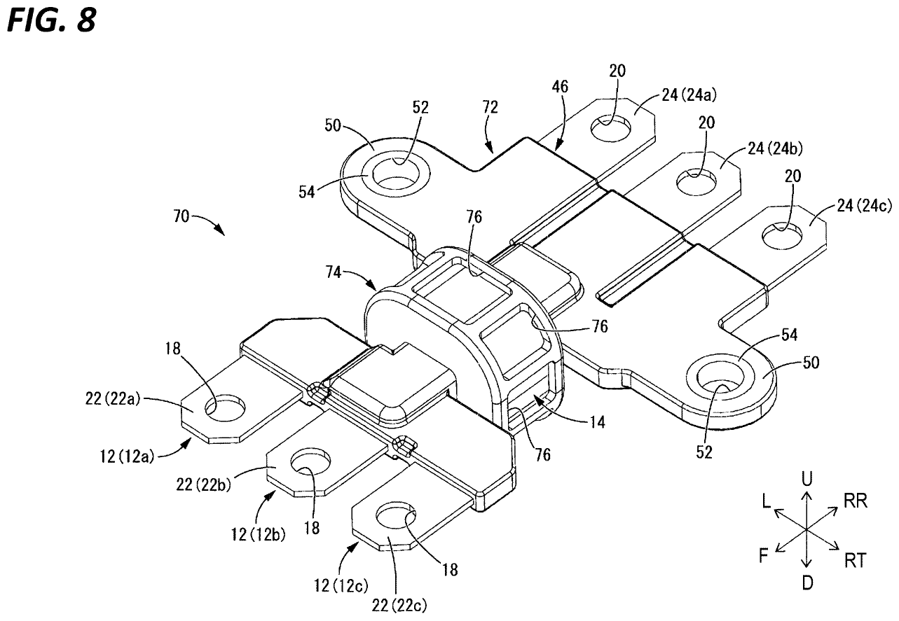

A ferrite core built-in connector 70 of a third embodiment of the present disclosure is described below using FIG. 8. The ferrite core built-in connector 70 of the third embodiment includes exposure holes 76 for exposing a ferrite core 14 in a peripheral wall portion of a core holding portion 74 of a connector housing 72, similarly to the ferrite core built-in connector 60 of the second embodiment. In this way, the ferrite core built-in connector 70 of the third embodiment can exhibit effects similar to those of the ferrite core built-in connector 60 of the second embodiment.

Note that, although the exposure holes 66 having a substantially oval cross-section are provided in the second embodiment, the exposure holes 76 having a substantially rectangular cross-section are provided in the third embodiment. Although the exposure holes 66 of the second embodiment are provided side by side in two rows in the front-rear direction, a plurality of the exposure holes 76 of the third embodiment are arranged in one row in the front-rear direction and provided at a plurality of positions in a circumferential direction of the core holding portion 74. One exposure hole 76 in the third embodiment has a larger cross-sectional area than one exposure hole 76 in the second embodiment, and a total sum of the cross-sectional areas of the plurality of exposure holes 76 is larger than that of the plurality of exposure holes 66 in the second embodiment. In this way, a resin material of the peripheral wall portion of the core holding portion 74 is made less than that of the peripheral wall portion of the core holding portion 64 in the second embodiment, with the result that a possibility of damage of the ferrite core 14 due to the shrinkage of the resin material during the molding of the core holding portion 74 and the like can be even more reduced.

### Fourth Embodiment

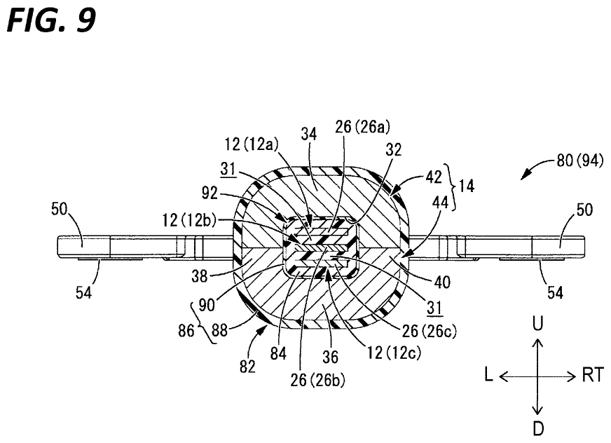

A ferrite core built-in connector 80 of a fourth embodiment of the present disclosure is described below using FIG. 9. In the ferrite core built-in connector 80 of the fourth embodiment, a connector housing 82 includes a first resin portion 84 for holding terminal fittings 12 in an embedded state and a second resin portion 86 for holding the first resin portion 84 and a ferrite core 14 in an embedded state.

The first resin portion 84 holds each of intermediate portions 26a to 26c of first to third terminal fittings 12a to 12b, front and rear coupling portions (28a, 28a) of the first terminal fitting 12a and front and rear coupling portions (28c, 28c) of the third terminal fitting 12c in the embedded state. The first resin portion 84 covers the outer peripheries of the intermediate portions 26a to 26c of the first to third terminal fittings 12a to 12c and is filled between the facing surfaces of the intermediate portions 26a to 26c facing in the vertical direction.

The second resin portion 86 is molded separately from the first resin portion 84 and covers the surface of the ferrite core 14. The second resin portion 86 is integrally provided with an outer surface covering portion 88 for covering the outer peripheral surface and axial end surfaces on both front and rear sides of the ferrite core 14 and an inner periphery filling portion 90 for filling between the inner peripheral surface of the ferrite core 14 and the facing surface of the first resin portion 84. The second resin portion 86 may be welded to the first resin portion 84 in the inner periphery filling portion 90. Since the first and second resin portions 84, 86 are separately molded, these can be made of resin materials different from each other.

The ferrite core built-in connector 80 of the fourth embodiment is formed as a secondary molded product (94), which is a molded product of the second resin portion 86. A manufacturing method of the ferrite core built-in connector 80 of the fourth embodiment is briefly described.

First, the first resin portion 84 is injection-molded with the first to third terminal fittings 12a to 12c and collars 54, 54 set in an injection mold for the first resin portion 84. In this way, a primary molded product 92 having the first to third terminal fittings 12a to 12c and the collars 54, 54 as inserts is formed.

Subsequently, the second resin portion 86 is injection-molded with the primary molded product 92 and the ferrite core 14 set in an injection mold for the second resin portion 86. In this way, the ferrite core built-in connector 80 is formed as the secondary molded product 94 having the primary molded product 92 and the ferrite core 14 as inserts.

The ferrite core 14 is set in the injection mold for the second resin portion 86 with the inner peripheral surface thereof separated from the primary molded product 92. In this way, the ferrite core 14 can be accurately arranged at a proper position with respect to the primary molded product 92. Then, the inner periphery filling portion 90 of the second resin portion 86 is formed between the inner peripheral surface of the ferrite core 14 and the facing surface of the primary molded product 92.

In this way, by separately molding the first and second resin portions 84, 86 constituting the connector housing 82, the amount of the resin during the molding of the secondary molded product 94 (second resin portion 86) including the ferrite core 14 as an insert can be reduced by as much as the first resin portion 84 as compared to the case where the entire connector housing is integrally molded. Therefore, a shrinkage force applied to the ferrite core 14 when the resin material of the second resin portion 86 is cured can be further reduced, and the damage of the ferrite core 14 can be more advantageously prevented.

Further, since the inner periphery filling portion 90 is provided which fills between the inner peripheral surface of the ferrite core 14 and the facing surface of the first resin portion 84, and formed integrally with the outer surface covering portion 88, the ferrite core 14 can be stably held in the embedded state around the first resin portion 84.

### Other Embodiments

The technique described in this specification is not limited to the above described and illustrated embodiments. For example, the following embodiments are also included in the technical scope of the technique described in this specification.

(1) Although the three terminal fittings 12 (first to third terminal fittings 12a to 12c) are provided in the above embodiments, two, four or more terminal fittings may be provided if a plurality of terminal fittings are provided.

(2) For example, the plate width of the intermediate portion in the terminal fitting may be equal to those of the first and second connecting portions or may be larger than those of the first and second connecting portions. Further, if the intermediate portion has a strip plate shape, the terminal fitting may not necessarily have a strip plate shape as a whole. For example, the first and second connecting portions may have a shape other than the strip plate shape such as a rod shape, an circular ring plate shape or a U-shape plate shape.

(3) Although the intermediate portions 26a to 26c of the first to third terminal fittings 12a to 12c are arranged to entirely overlap each other in projection in the vertical direction in the above embodiments, intermediate portions of a plurality of terminal fittings may partially overlap each other in projection in the vertical direction. Specifically, for example, the intermediate portion 26a of the first terminal fitting 12a in the above embodiments may be arranged at a position shifted leftward with respect to the intermediate portion 26b of the second terminal fitting 12b, a right part of the intermediate portion 26a may overlap the intermediate portion 26b in the vertical direction and a left part of the intermediate portion 26a may not overlap the intermediate portion 26b in the vertical direction.

(4) Although the intermediate portion 26a of the first terminal fitting 12a and the intermediate portion 26c of the third terminal fitting 12c overlap and sandwich the intermediate portion 26b of the second terminal fitting 12b from both upper and lower sides in the above embodiments, the intermediate portion 26b of the second terminal fitting 12b and the intermediate portion 26c of the third terminal fitting 12c may be arranged to overlap and sandwich the intermediate portion 26a of the first terminal fitting 12a from the both upper and lower sides. In this case, the first connecting portions 22a to 22c can be arranged at the same height position in the plate thickness direction by providing the first and third terminal fittings 12a, 12c with stepped portions 30a, 30c projecting in the same vertical direction from the intermediate portions 26a, 26c and having different projecting amounts, or providing a stepped portion between the intermediate portion 26b and the first connecting portion 22b in the second terminal fitting 12b instead without providing the stepped portion on the first terminal fitting 12a.

(5) The first connecting portions are not limited to those separated from each other and arranged in parallel in the plate width direction and, for example, may be disposed at the same position in the plate width direction and separated from each other and arranged in parallel in the plate thickness direction. Therefore, none of the terminal fittings may be possibly provided with a coupling portion.

(6) If the first connecting portions of the plurality of terminal fittings are separated from each other and arranged in parallel in the plate width direction, those first connecting portions may not necessarily be arranged at the same height position in the plate thickness direction. Therefore, even if at least one terminal fitting is provided with a coupling portion, it is not essential that the coupling portion is provided with a stepped portion.

(7) Exposure holes may be formed to penetrate through parts covering axial end surfaces of a ferrite core in a core holding portion instead of or in addition to a part covering the outer peripheral surface of the ferrite core in the core holding portion. Note that a penetration direction of the exposure hole penetrating through the core holding portion is not particularly limited.

(8) Although the plurality of exposure holes 66, 76 penetrating through the outer peripheral wall portion of the core holding portion 48 of the connector housing 16 are illustrated in the second and third embodiments, an outer peripheral wall portion of a core holding portion may be, for example, eliminated and the core holding portion may be constituted by a wall portion for covering both axial ends and the inner peripheral surface of a ferrite core and have a concave cross-section open toward an outer peripheral side. Also by this, the amount of a resin material for forming the core holding portion can be reduced and the damage of the ferrite core due to shrinkage after the molding of the core holding portion can be more effectively prevented. Note that the core holding portion may have a concave cross-section open in the axial direction by eliminating parts for covering the both axial end surfaces of the ferrite core in the core holding portion.

### LIST OF REFERENCE NUMERALS

10 ferrite core built-in connector (first embodiment)
12 terminal fitting
12a first terminal fitting
12b second terminal fitting
12c third terminal fitting
14 ferrite core
16 connector housing
18 front through hole
20 rear through hole
22 (22a to 22c) first connecting portion
24 (24a to 24c) second connecting portion
26 (26a to 26c) intermediate portion
28 (28a, 28c) coupling portion
30 (30a, 30c) stepped portion
31 gap
32 internal space
34 upper part
36 lower part
38 left part
40 right part
42 upper ferrite core
44 lower ferrite core
46 terminal holding portion
48 core holding portion
50 leg portion
52 bolt insertion hole
54 collar
60 ferrite core built-in connector (second embodiment)
62 connector housing
64 core holding portion
66 exposure hole
70 ferrite core built-in connector (third embodiment)
72 connector housing
74 core holding portion
76 exposure hole
80 ferrite core built-in connector (fourth embodiment)
82 connector housing
84 first resin portion
86 second resin portion
88 outer surface covering portion
90 inner periphery filling portion
92 primary molded product
94 secondary molded product

1. A ferrite core built-in connector, comprising:
a plurality of terminal fittings each configured such that a first connecting portion and a second connecting portion are coupled by an intermediate portion having a strip plate shape;
a ferrite core arranged to collectively surround the intermediate portions of the plurality of terminal fittings; and
a connector housing for accommodating parts of the plurality of terminal fittings except the first and second connecting portions and the ferrite core in an embedded state,
the intermediate portions of the plurality of terminal fittings being separated from each other across a gap in a plate thickness direction and arranged to overlap each other in projection in the plate thickness direction.

2. The ferrite core built-in connector of claim 1, wherein:
at least one of the plurality of terminal fittings includes a coupling portion extending in a plate width direction of the intermediate portion from an end part of the intermediate portion on the first connecting portion side and the first connecting portion coupled to the intermediate portion by the coupling portion is arranged at a position shifted from an extension of the coupling portion in the plate width direction, and
the first connecting portions of the plurality of terminal fittings overlapped in the plate thickness direction in the intermediate portions are separated from each other across a gap and arranged in parallel in the plate width direction.

3. The ferrite core built-in connector of claim 2, wherein:
at least one of the terminal fittings including the coupling portion includes a stepped portion bent into a crank shape in the plate thickness direction on the coupling portion and the intermediate portion and the first connecting portion provided on both sides of the stepped portion are arranged at height positions shifted from each other in the plate thickness direction, and
the first connecting portions of the plurality of terminal fittings overlapped in the plate thickness direction in the intermediate portions are arranged at the same height position in the plate thickness direction by the stepped portion.

4. The ferrite core built-in connector of claim 1, wherein the connector housing is made of a resin material having a higher heat resistance than PVC.

5. The ferrite core built-in connector of claim 1, wherein the connector housing includes a terminal holding portion for holding parts of the plurality of terminal fittings except the first and second connecting portions in an embedded state and a core holding portion molded integrally with the terminal holding portion, the core holding portion holding the ferrite core in an embedded state.

6. The ferrite core built-in connector of claim 1, wherein the connector housing includes a first resin portion for holding parts of the plurality of terminal fittings except the first and second connecting portions in an embedded state and a second resin portion molded separately from the first resin portion, the second resin portion holding the first resin portion and the ferrite core in an embedded state.

7. The ferrite core built-in connector of claim 1, wherein the connector housing includes an exposure hole for exposing the ferrite core.

8. The ferrite core built-in connector of claim 1, wherein the first and second connecting portions of each terminal fitting respectively project and are exposed from the connector housing on both axial sides of the tubular ferrite core.
